(19) United States
(12) Patent Application Publication
(10) Pub. No.: US 2005/0289086 A1
(43) Pub. Date: Dec. 29, 2005

(54) Anonymous payment system

(76) Inventor: Abdul Ali Oluwagbemileke Afariogun, Streatham (GB)

Correspondence Address: MR ABDUL ALI OLUWAGBEMILEKE AFARIOGUN, 7, FLAT 4 STREATHAM COMMON SOUTH, STREATHAM, LONDON, SW16 3BT, GB

(21) Appl. No.: 10/877,199

(22) Filed: Jun. 28, 2004

(51) Int. Cl. G06F 17/60

(52) U.S. Cl. 705/74

(57) ABSTRACT

A payment system which, allows a buyer to pay for goods/services without disclosing personal information such as names and addresses. This payment system can be used for remote transaction such as online or telephone payments.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention relates to a business process, which enables remote transactions to be settled anonymously.

There are currently several ways of making remote payments such as using credit cards, debit cards etc. However, these methods require buyers to disclose their personal information including their name and address to the seller.

The mere fact that buyers have to disclose personal information when making a remote payment (i.e. over the internet) is a cause of major concern for some buyers who have concerns relating to security and privacy.

Several attempts have been made to address these concerns, nevertheless, the resulting solutions still require a buyer to disclose their valuable personal information to a third party such an agent.

### BRIEF SUMMARY OF THE INVENTION

The APS will allow buyers to pay for goods or services remotely without having to disclose personal information including their names and addresses. This payment solution will tackle problems relating to the security and privacy issues so strongly associated with online payments.

One of the biggest set backs of e-commerce is the seemly insurmountable fraud/security issues relating to online payment using credit or debit cards. Many buyers also have privacy concerns surrounding the disclosure of personal information when making online or telephone payments.

With the APS a buyer would not have to disclose personal information, even to a third party in order to make a remote payment and therefore maintaining their privacy.

The APS will also seriously reduce the security issues relating to making remote payment for the buyer as well as reducing charge backs to sellers.

### BRIEF DESCRIPTION OF THE SEVERAL VIEW OF THE DRAWING

FIG. 1—Registration process of the anonymous payment system

FIG. 2—The process of crediting the anonymous payment system account

FIG. 3—Making payments for goods and services using the anonymous payment system

FIG. 4—The process of arranging delivery following FIG. 3

### DETAILED DESCRIPTION OF THE INVENTION

This invention combines a number of business processes to provide a new method of making remote payment anonymously.

The process of this payment system is set out below:

Registration

A buyer will register once at the authorised website using the APS.

Following the registration process the buyer would receive unique account logon details (such as a username and password). A user name will act as a substitute for the buyer's own name and therefore uniquely identifies that buyer.

The buyer will also be given details of how to use the anonymous mode of communicating with the appropriate party being either the authorised website or a third party seller. An example of how the anonymous mode of communication can be executed could be a type of email service whereby the parties will only be able to send emails within that domain.

The registration process would not require the buyer to disclose any personal information.

Crediting the Account

The buyer must ensure his account remains in credit in order to make successfully conclude their purchases.

Buyers are able to credit their accounts in various ways including but not limited to automated machines or an agent of the APS.

The buyer's account will be identified by his account details (i.e. username).

Making payments

In order to make payments using the APS the buyer will apply to withdraw the necessary sum required for the purchase by simply logging on to his account (an application).

For each granted application (as described above) the withdrawal is uniquely associated with an individual code which represents the buyers granted sum (hereinafter referred to as the “moneycode™”).

A unique moneycode ™ is applied to every application. Once that particular moneycode™ has been validated by the seller it becomes redundant regardless of whether or not all sums pertaining to that moneycode™ has been spent, any unused funds will be credited back to the buyer's account.

The aforementioned paragraph sets out one of the unique selling points of APS, because a new moneycode™ is generated for each purchase this in itself will be fundamental to allying buyers remote purchasing fears, that their financial details maybe compromised either by reason of fraud or due to the lack of security at the buyers website.

Paying for Products/Services that Do Not Require Delivery.

Bearing in mind the registration process detailed at the Registration paragraph above, at the point of purchase, the buyer will simply present the relevant money code™, username and communication details for example username@company.com.

The moneycode™ will be verified and authenticated by the seller through the APS.

Products/Services that Require Delivery

When a transaction involves the delivery of goods, the seller will ask the APS for a permit to deliver, in order to locate the nearest point of collection, the buyer will enter part of the relevant geographical area for example zip/post code. APS will return a list of agents and their addresses where the buyer can then select and arrange for the collection of their product at their preferred agent location.

Once an agent has been selected the APS would carry out the following:
Send a purchase code to the seller and buyer; and
Send an ownership code to the buyer.

As with moneycodes™, purchase codes and ownership codes can only be used once, the purchase codes and ownership codes are generated automatically, however for security reasons the buyer will be the only party privy to the ownership code until such a time that it is disclosed to the agent for collection of the goods.

The seller will arrange for the product to be sent to the chosen agent, the package will contain very limited information i.e. the purchase code and the preferred agents address. Upon the agent's receipt of the package, notification will be made to APS using the purchase code.

Following the delivery notification to APS the buyer will be informed that their package is available for collection. The buyer armed with their ownership code can collect the package from the agent.

The agent will use the purchase code in order to carry out the final checks to ensure that the provided purchase codes matches the purchase code on the package.

The agent will not relinquish a package without the correct purchase code.

1.1 What I claim as my invention is a payment system that uses a combination of anonymous messaging service and unique codes to enable a purchaser to pay for goods and/or services remotely. Furthermore the service will allow the purchaser to take delivery of the goods and/or services without the requirement to disclose personal information.

2.1 A payment system as claimed in claim 1.1, wherein a buyer can pay for goods and/or services anonymously.

3.1 A payment system as claimed in claim 1.1 or claim 2.1, wherein it can be used for non remote payments.

4.1 A payment system as claimed in claim 1.1, wherein an order is represented by a unique code called a purchase code.

5.1 A payment system as claimed in claim 1.1, wherein the ownership of a goods orders can be claimed by the presentation of a uniquely generated ownership code.

6.1 A payment system as claimed in claim 1.1 or claim 4.1, wherein an order can also by represented by the purchaser's username.

7.1 A payment system as claimed in claim 1.1 or claim 5.1, wherein the ownership of an order can also be established by the use of a password.

8.1 A payment system as claimed in claim 1.1 or claim 5.1 or claim 6.1, wherein the ownership of an order can also be established through a registration process whereby a purchaser will be able to collect goods and/or services at a preferred outlet subject to prior registration and the production of identification including but not limited to a card, signature or password.

9.1 A payment system as claimed in claim 1.1, wherein a buyer is given an anoymous mode of comunicating with the retailers, merchants, wholesalers, businessse or industry (this list is not exhaustive) and the anonymous payment and its representatives and agents.

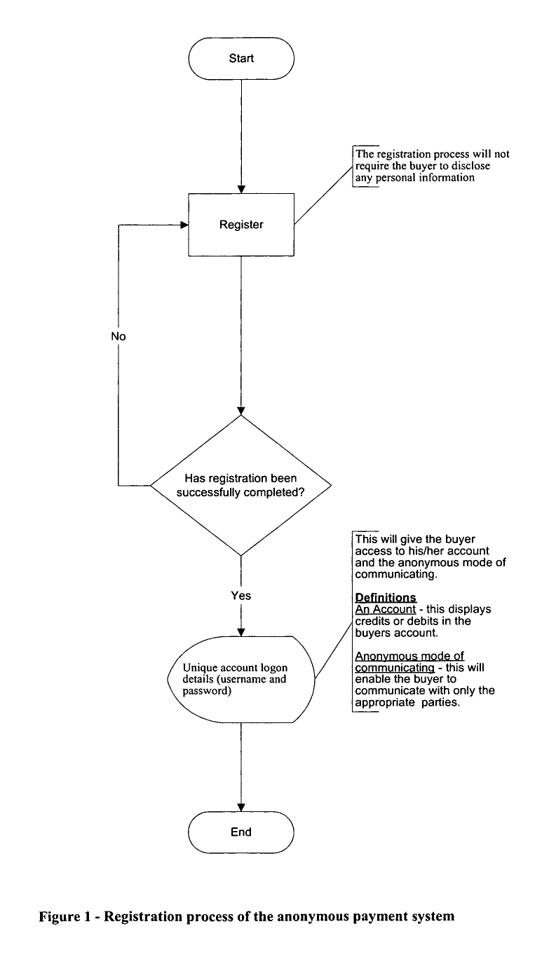

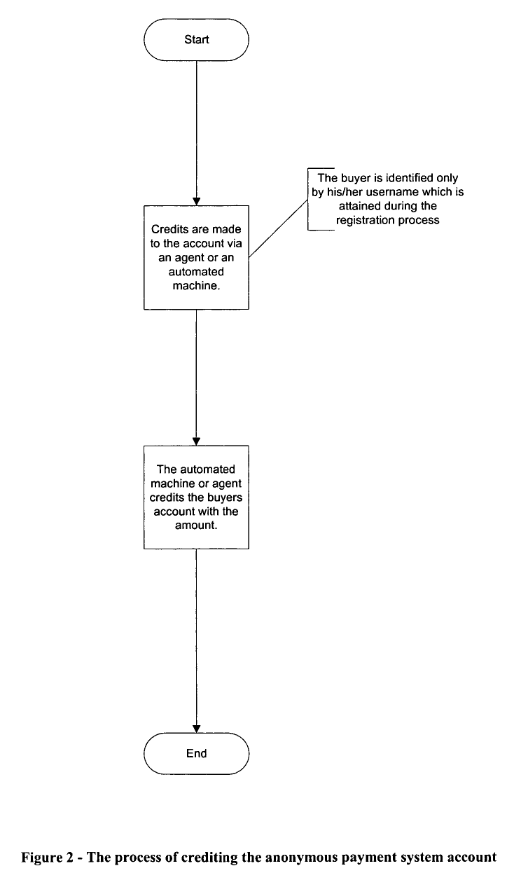

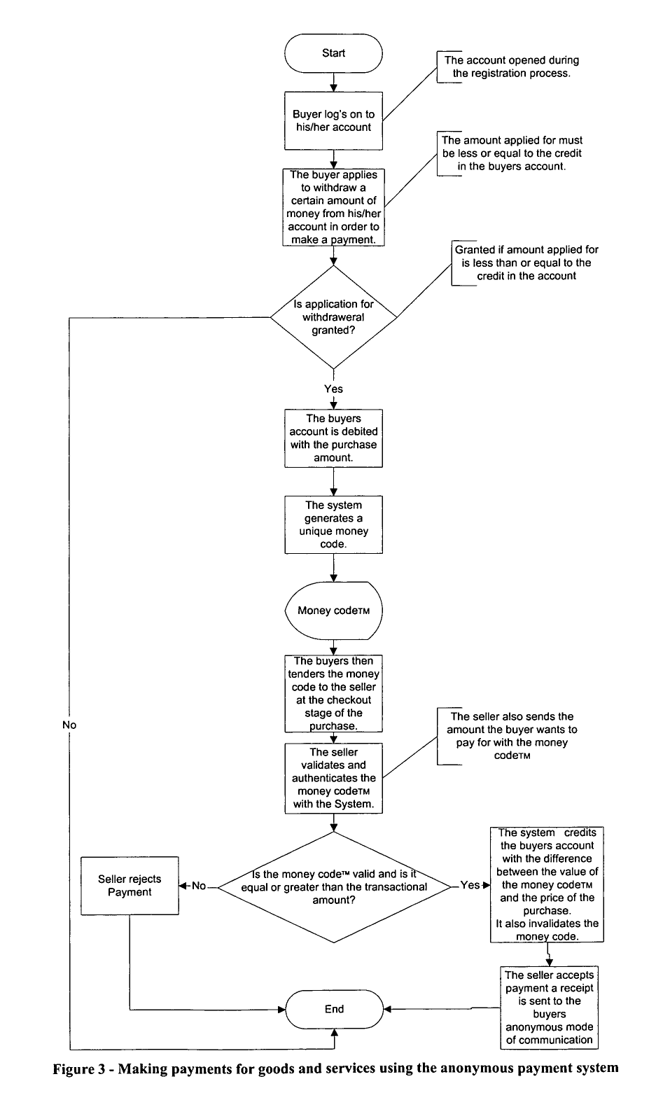

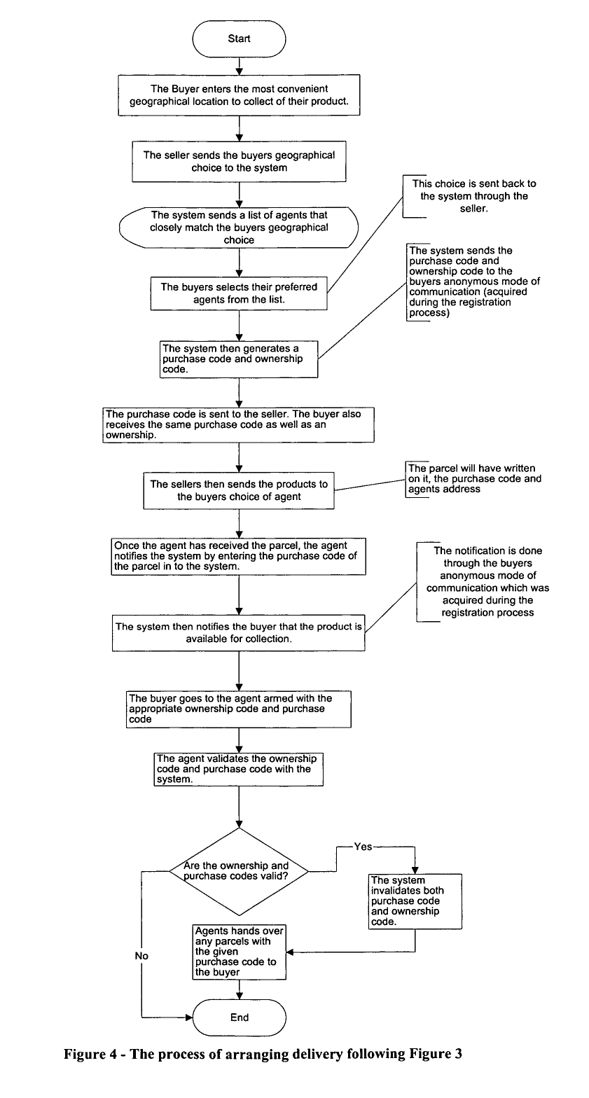

10.1 A payment system substantially as described herein with reference to FIGS. 1-4 of the accompanying drawing.
